(19) United States
(12) Patent Application Publication
(10) Pub. No.: US 2024/0262426 A1
(43) Pub. Date: Aug. 8, 2024

(54) FRONT SIDE MEMBER

(71) Applicant: TOYOTA JIDOSHA KABUSHIKI KAISHA, Toyota-shi (JP)

(72) Inventor: Soshiro MURATA, Toyota-shi (JP)

(21) Appl. No.: 18/413,027

(22) Filed: Jan. 16, 2024

(30) Foreign Application Priority Data
Feb. 8, 2023 (JP) 2023-017949

(51) Int. Cl. B62D 21/15

(52) U.S. Cl. CPC B62D 21/152

(57) ABSTRACT

A front side member extends in a vehicle front-rear direction at each of both left and right sides in a vehicle width direction, has an open cross-sectional shape in which an opening is provided at at least one side thereof in the vehicle width direction, and is integrally molded by die casting. The front side member includes plural ribs that connect a bottom surface at a side opposite from the opening, a lower surface of an upper wall in a vehicle up-down direction, and an upper surface of a lower wall in the vehicle up-down direction. A minimum rib height of the ribs along the vehicle width direction is set to be equal to or greater than half of a width direction dimension D of the upper wall and the lower wall.

### CROSS-REFERENCE TO RELATED APPLICATION

This application is based on and claims priority under 35 USC § 119 from Japanese Patent Application No. 2023-017949, filed on Feb. 8, 2023, the disclosure of which is in corporated by reference herein.

### TECHNICAL FIELD

The present disclosure relates to a front side member.

### RELATED ART

International Publication (WO) No. 2022/031991 (Patent Document 1) discloses a structure that absorbs energy by breaking a frame member that is formed by integral molding by casting or the like, at the time of a collision. The frame member described in Patent Document 1 has a U-shaped cross-sectional shape in which a direction perpendicular to a load transmission direction is a mold opening direction and the mold opening direction is open. Further, the frame member includes plural chambers separated by wall-shaped ribs that are perpendicular to the load transmission direction, and the ribs are hollowed out in a C-shape.

In the frame member described in Patent Document 1, when a collision load is applied and the frame member is successively crushed from a leading end, deformation of a second chamber is dragged along accompanying collapse of a first chamber, and a wall thereof buckles in a direction opposite to the first chamber. Accordingly, in a case in which a wall of the first chamber undergoes convex deformation so as to be convex in an outer side direction, walls of even-numbered chambers undergo deformation so as to be convex in an inner side direction, namely, they undergo concave deformation, and thus, fragments may remain at a frame member interior, whereby incomplete crushing may occur. When incomplete crushing occurs, vehicle deformation (stroke) cannot be sufficiently achieved by an amount corresponding to the amount of the incomplete crushing, and energy absorption efficiency decreases. On the other hand, if the hollowed-out portion that is hollowed out in a C-shape is eliminated in order to suppress the occurrence of incomplete crushing, there may be cases in which a crushing load in the respective chambers becomes too large even if the occurrence of incomplete crushing can be suppressed, and an intended energy absorption amount cannot be secured.

### SUMMARY

In consideration of the above facts, an object of the present disclosure is to provide a front side member capable of reducing a decrease in energy absorption efficiency due to incomplete crushing and securing an intended energy absorption amount.

A front side member according to a first aspect is a front side member that extends in a vehicle front-rear direction at each of both left and right sides in a vehicle width direction, that has an open cross-sectional shape in which an opening is provided at at least one side thereof in the vehicle width direction, and that is integrally molded by die casting, wherein the front side member includes plural ribs that connect a bottom surface at a side opposite from the opening, a lower surface of an upper wall in a vehicle up-down direction, and an upper surface of a lower wall in the vehicle up-down direction, and a minimum rib height of the ribs along the vehicle width direction is set to be equal to or greater than half of a width direction dimension of the upper wall and the lower wall.

The front side member according to the first aspect has an open cross-sectional shape in which the opening is provided at at least one side thereof in the vehicle width direction, and is integrally molded by die casting. Further, the front side member includes the plural ribs that connect the bottom surface at the side opposite from the opening, the lower surface of the upper wall in the vehicle up-down direction, and the upper surface of the lower wall in the vehicle up-down direction. By reinforcing the wall surfaces with the plural ribs in this manner, when a certain chamber among plural chambers respectively separated by the plural ribs has been broken, deformation within the certain chamber is completed. Consequently, a tendency of deformation, such as a concave shape, a convex shape or the like, is not propagated to a wall surface of a chamber that is adjacent to the certain chamber. This enables vehicle up-down direction wall surfaces of all of the chambers to be bent so as to be convex toward the outer side direction of the front side member. Consequently, accumulation of broken fragments due to a collision load applied to the front side member at an interior of the front side member can be suppressed, and therefore, a decrease in energy absorption efficiency due to incomplete crushing can be reduced.

Further, in the front side member according to the first aspect, the minimum rib height of the ribs along the vehicle width direction is set to be equal to or greater than half of the width direction dimension of the upper wall and the lower wall. By adjusting the minimum rib height, namely, a hollowing-out amount of hollowed-out portions that are hollowed out from an opening side in the vehicle width direction, in this manner, a crushing load in the chambers partitioned by the ribs can be controlled, and therefore, an intended energy absorption amount can be secured.

A front side member according to a second aspect is the front side member according to the first aspect, wherein the minimum rib height is set so as to increase toward a vehicle rear.

In the front side member according to the second aspect, the minimum rib height is set so as to increase toward the vehicle rear. Namely, the hollowing-out amount of the hollowed-out portions decreases toward the vehicle rear. Consequently, since the crushing load increases from the vehicle front side of the front side member toward the rear, the crushing can be made easier to occur in order from the vehicle front side, and robustness of deformation during a collision can be improved.

A front side member according to a third aspect is the front side member according to the first aspect or the second aspect, wherein the open cross-sectional shape is a U-shaped cross-sectional shape, and the opening is provided at an outer side in the vehicle width direction.

According to the front side member according to the third aspect, since the cross-sectional shape thereof is a U-shaped cross-sectional shape and the opening is provided at the outer side in the vehicle width direction, a wall is present at the inner side in the vehicle width direction. Consequently, flying of fragments toward, for example, a power unit disposed at the vehicle width direction inner side can be suppressed.

A front side member according to a fourth aspect is the front side member according to the first aspect or the second aspect, wherein the open cross-sectional shape is an H-shaped cross-sectional shape, and the opening is provided at each of an inner side and an outer side in the vehicle width direction.

According to the front side member according to the fourth aspect, since the cross-sectional shape thereof is an H-shaped cross-sectional shape and the opening is provided at the inner side and the outer side in the vehicle width direction, a wall is present at a vehicle width direction central portion of the front side member. Consequently, the crushing load can be controlled at both sides of the front side member in the vehicle width direction.

A front side member according to a fifth aspect is the front side member according to any one of the first aspect to the fourth aspect, wherein the ribs comprise hollowed-out portions in which a leading end is hollowed out in an arc shape from an opening side in the vehicle width direction.

In the front side member according to the fifth aspect, since the leading ends of the hollowed-out portions provided at the ribs are hollowed out in an arc shape, a central portion of the front side member in the vehicle up-down direction is more easily crushed, and convex deformation that becomes convexities toward the outer sides at the wall surfaces in the vehicle up-down direction occurs more easily.

As described above, the front side member according to the present disclosure has an excellent advantageous effect in that a decrease in energy absorption efficiency due to incomplete crushing can be reduced, and an intended energy absorption amount can be secured.

### BRIEF DESCRIPTION OF THE DRAWINGS

FIG. 1 is a plan view schematically illustrating an example of a main section of a vehicle front section including a front side member according to a first exemplary embodiment of the present invention.

FIG. 2 is a perspective view of the front side member, viewed from an obliquely forward side of a vehicle.

FIG. 3 is a cross-sectional view taken along line A-A in FIG. 2.

FIG. 4 is a cross-sectional view illustrating a modified example corresponding to FIG. 3.

FIG. 5 is a perspective view of a front side member of Comparative Example 1, viewed from an obliquely forward side of a vehicle.

FIG. 6 is a side view schematically illustrating an analysis result when a collision load has been applied to the front side member of Comparative Example 1 in FIG. 5.

FIG. 7 is a diagram schematically illustrating an analysis result when a collision load has been further applied to the front side member of Comparative Example 1 from a state in FIG. 6.

FIG. 8 is a vertical cross-sectional view of a front side member of Comparative Example 2.

FIG. 9 is a side view schematically illustrating an analysis result when a collision load has been applied to the front side member of Comparative Example 2.

FIG. 10 is a diagram schematically illustrating an analysis result when a collision load has been further applied to the front side member of Comparative Example 2 from a state in FIG. 9.

FIG. 11 is a side view schematically illustrating a state in which incomplete crushing has occurred.

FIG. 12 is a perspective view of a front side member according to a second exemplary embodiment of the present invention, viewed from an obliquely forward side of a vehicle.

FIG. 13 is a cross-sectional view taken along line B-B in FIG. 12.

### DETAILED DESCRIPTION

### Exemplary Embodiment 1

Explanation follows regarding a vehicle front structure 100 including a front side member 10 according to a first exemplary embodiment of the present invention, with reference to the drawings. It should be noted that, since the vehicle front structure 100 is a bilaterally symmetrical structure, only a left side portion is illustrated in the drawings, and description of a right side portion is omitted. Further, arrow FR appropriately illustrated in the respective drawings indicates a front side in a vehicle front-rear direction, and arrow UP indicates an upper side in a vehicle up-down direction. Furthermore, arrow LH indicates a left side in a vehicle width direction and, in the present exemplary embodiment, indicates a vehicle width direction outer side. It should be noted that, in the present exemplary embodiment, for simplicity, explanation follows assuming that the vehicle left side is the vehicle width direction outer side, and that a vehicle right side is a vehicle width direction inner side (vehicle width direction central side). In the following, in cases in which explanation is given by simply using front-rear, up-down, and left-right directions, these respectively indicate front and rear in the vehicle front-rear direction, up and down in the vehicle up-down direction, and left and right in the vehicle left-right direction (vehicle width direction), unless otherwise specified. Further, for example, as in a case in which a configuration having bilateral symmetry with respect to the configuration of the present exemplary embodiment is provided, the present disclosure can be applied even in a configuration in which the vehicle right side is the vehicle width direction outer side, and the vehicle left side is the vehicle width direction inner side (vehicle width direction central side).

### Configuration of Vehicle Front Structure

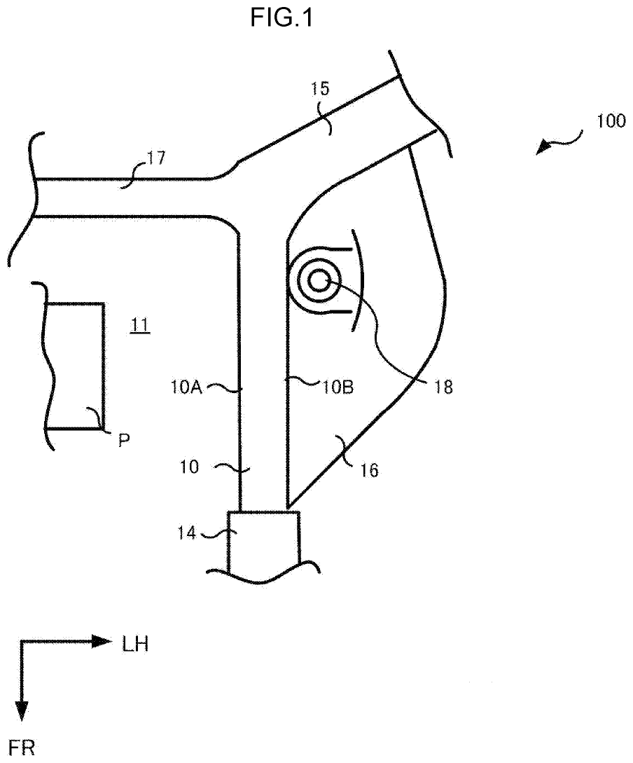

First, explanation follows regarding a configuration of the vehicle front structure 100. FIG. 1 is a plan view schematically illustrating an example of a main section of a vehicle front section including the front side member 10 according to the first exemplary embodiment of the present invention. As illustrated in FIG. 1, in the present exemplary embodiment, the vehicle front structure 100 is incorporated into an electric vehicle such as an electric automobile, a fuel cell automobile or the like that travels with power generated by a power unit P, for example. A power unit chamber 11 in which the power unit P is installed is provided at the vehicle front section.

The vehicle front structure 100 is a side frame member of the vehicle, and includes a pair of left and right front side members 10 disposed at both vehicle width direction sides of the vehicle front section. The front side member 10 extends in the vehicle front-rear direction, and an end portion at a vehicle rear side of the front side member 10 is connected to a cross member (not illustrated in the drawings). Moreover, a vehicle front end portion of the front side member 10 is connected to a front bumper reinforcement (not illustrated in the drawings; hereafter referred to as a “bumper RF”) disposed along the vehicle width direction. In the present exemplary embodiment, as an example, a crash box 14 serving as an energy absorbing member is interposed between the front side member 10 and the bumper RF.

The crash box 14 is configured so as to deform before the front side member 10 deforms and absorb a portion of the energy of a collision when the vehicle undergoes a front collision. When an impact load is transmitted from the bumper RF to the crash box 14, the crash box 14 is compressed in the front-rear direction.

A pair of left and right apron upper members 15 extending in the vehicle up-down direction are disposed at vehicle width direction outer sides of vehicle rear sides of the front side members 10. Further, a pair of left and right fender aprons 16 are disposed at vehicle width direction outer sides of the front side members 10 and at vehicle front sides of the apron upper members 15. The apron upper members 15 each have a generally rectangular cross-sectional shape in which a vehicle width direction outer side thereof is open.

A dash panel 17 is disposed at a vehicle rear side of the front side members 10 and between the pair of left and right apron upper members 15. The dash panel 17 is a member that separates the power unit chamber 11 and a vehicle cabin (not illustrated in the drawings), and extends in the vehicle width direction and the vehicle up-down direction with a plate thickness direction thereof being the vehicle front-rear direction. Vehicle width direction end portions of the dash panel 17 are connected to the fender aprons 16.

Meanwhile, a suspension tower 18 is provided at a vehicle upper side at a vehicle width direction outer side of a vehicle rear side of each front side member 10. A vehicle lower side of the suspension tower 18 is joined to the fender apron 16, and the fender apron 16 is formed so as to bulge toward the vehicle width direction inner side, and also formed with a wheel house in which a front wheel, which is not illustrated in the drawings, is housed so as to be steerable.

The suspension tower 18 is provided so as to project from the wheel house, namely, a bulging portion, of the fender apron 16 in a generally cylindrical shape toward the vehicle upper side. A shock absorber and a spring configuring a suspension, which is not shown in the drawings, that supports the front wheel housed in the wheel house of the fender apron 16 are housed at an interior of the suspension tower 18.

Further, the vehicle front structure 100 including at least the pair of left and right front side members 10 and the pair of left and right suspension towers 18 is integrally molded by aluminum die casting. It should be noted that, in the present exemplary embodiment, the pair of left and right front side members 10, the pair of left and right suspension towers 18, and peripheral components of the pair of left and right suspension towers 18, namely, the apron upper members 15, the fender aprons 16, and the dash panel 17, are integrally molded by aluminum die casting.

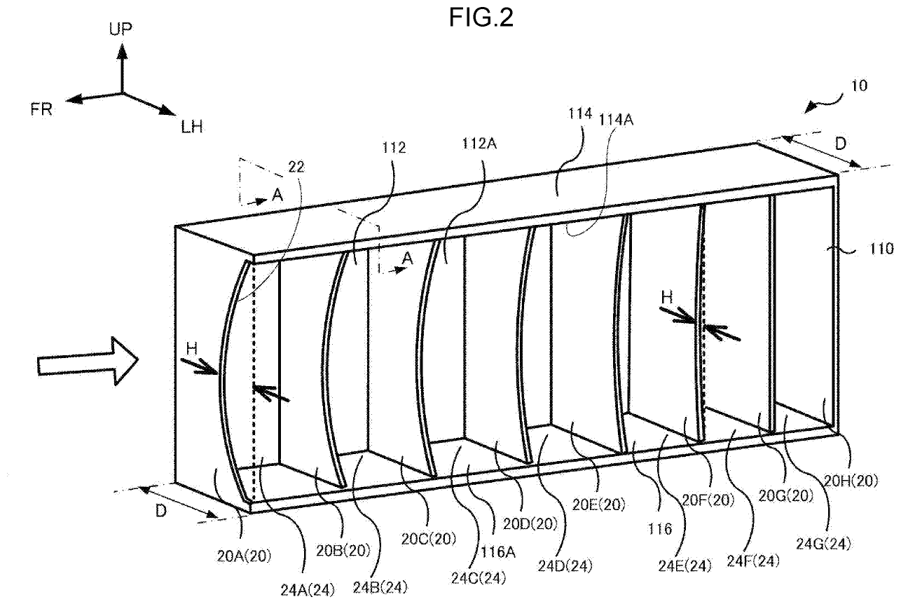

Next, explanation follows regarding a structure of the front side member 10. It should be noted that, in the present exemplary embodiment, as illustrated in FIG. 1, explanation follows with a vehicle right side surface of the front side member 10 being regarded as an inner side surface 10A, and with a vehicle left side surface of the front side member 10 being regarded as an outer side surface 10B. FIG. 2 is a perspective view illustrating a schematic configuration of a front end portion of the front side member 10.

As illustrated in FIG. 2, the front side member 10 has an open cross-sectional shape in which an outer side thereof in the vehicle width direction is open, and specifically has a U-shaped cross-sectional shape. The front side member 10 is provided with an opening 110 at an outer side thereof in the vehicle width direction, and includes a bottom wall 112 at a side opposite from the opening 110, namely, at a vehicle width direction inner side. Further, the front side member 10 includes an upper wall 114 at a vehicle upper side thereof and a lower wall 116 at a vehicle lower side thereof.

The front side member 10 includes plural ribs 20, in the vehicle front-rear direction, that connect a bottom surface 112A at a vehicle width direction outer side (left side) of the bottom wall 112, a lower surface 114A at a lower side of the upper wall 114, and an upper surface 116A at an upper side of the lower wall 116. As an example, the front side member 10 of the present exemplary embodiment includes eight ribs 20, which are a first rib 20A to an eighth rib 20H, from the vehicle front side to the vehicle rear side.

As illustrated in FIG. 2, in the front side member 10, single chambers 24 are respectively formed by adjacent ribs 20, the bottom surface 112A, the lower surface 114A, and the upper surface 116A. As an example, the front side member 10 of the present exemplary embodiment includes seven chambers 24 including a first chamber 24A to a seventh chamber 24G.

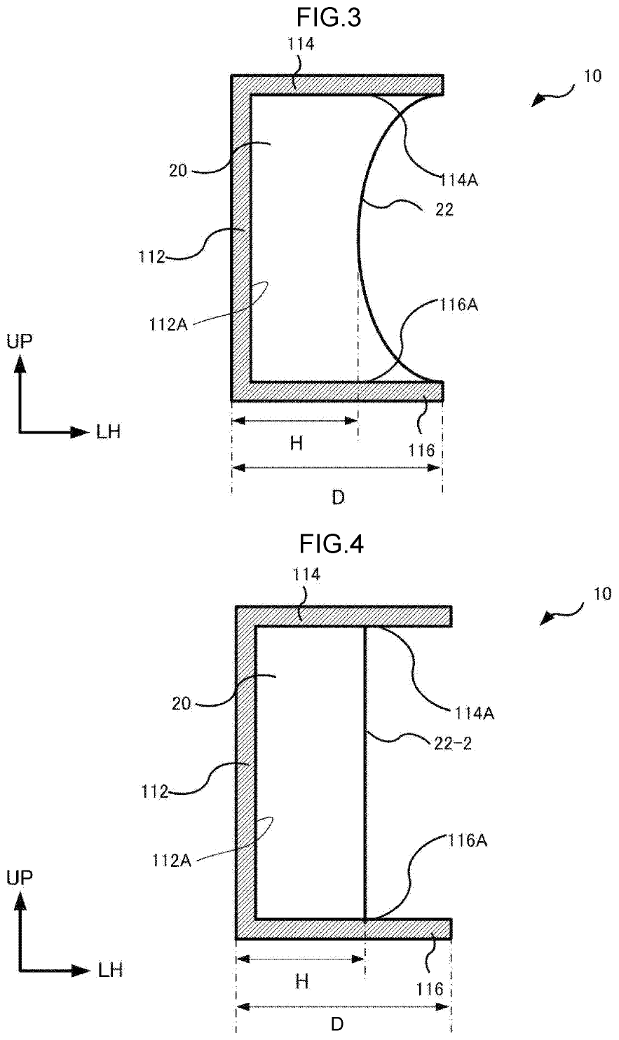

FIG. 3 is a cross-sectional view taken along line A-A in FIG. 2. As illustrated in FIG. 2 and FIG. 3, as an example, among the plural ribs 20, the first rib 20A to the sixth rib 20F are provided with a hollowed-out portion 22 at which a leading end is hollowed out in an arc shape from an opening 110 side toward an inner side in the vehicle width direction. In the present exemplary embodiment, as illustrated in FIG. 3, a height of the rib 20 at a position at which the height along the vehicle width direction is lowest is set as a minimum rib height H, and dimensions of the upper wall 114 and the lower wall 116 in the vehicle width direction are set as a width direction dimension D. The minimum rib height H is set to be equal to or greater than half of the width direction dimension D, namely, H≥ D/2.

As illustrated in FIG. 2, the minimum heights H of the first rib 20A to the sixth rib 20F are set to be higher on progression from the vehicle front toward the vehicle rear, namely, from the first rib 20A toward the sixth rib 20F. In other words, a width direction of the hollowed-out portion 22 of each rib 20 is hollowed out so as to be smaller on progression from the first rib 20A toward the sixth rib 20F.

It should be noted that, although the ribs 20 are provided with the hollowed-out portions 22 at which the leading end is hollowed out in an arc shape in the present exemplary embodiment as illustrated in FIG. 3, the present disclosure is not limited thereto. For example, as illustrated in FIG. 4 as a modified example, the leading end of each hollowed-out portion 22-2 may be hollowed out in a linear shape.

### Operation and Effects of First Exemplary Embodiment

Next, explanation follows regarding operation and advantageous effects of the first exemplary embodiment.

The front side member 10 according to the first exemplary embodiment has a U-shaped cross-sectional shape with the opening 110 provided at the outer side in the vehicle width direction, and is integrally molded by aluminum die casting. Moreover, the front side member 10 includes the plural ribs 20 that connect the bottom surface 112A at the side opposite from the opening 110, the lower surface 114A of the upper wall 114 in the vehicle up-down direction, and the upper surface 116A of the lower wall 116 in the vehicle up-down direction. By reinforcing the wall surfaces with the plural ribs 20 in this manner, when a certain chamber 24 among the plural chambers 24 respectively separated by the plural ribs 20 has been broken, deformation due to breakage within the certain chamber 24 is completed.

Consequently, a tendency of deformation, such as a concave shape, a convex shape or the like, is not propagated to a wall surface of a chamber 24 that is adjacent to the certain chamber 24. This enables vehicle up-down direction wall surfaces of all of the chambers 24 to be bent so as to be convex toward the outer side direction of the front side member 10. Consequently, accumulation of broken fragments due to the collision load applied to the front side member 10 at the interior of the front side member 10 can be suppressed, and therefore, a decrease in energy absorption efficiency due to incomplete crushing can be reduced.

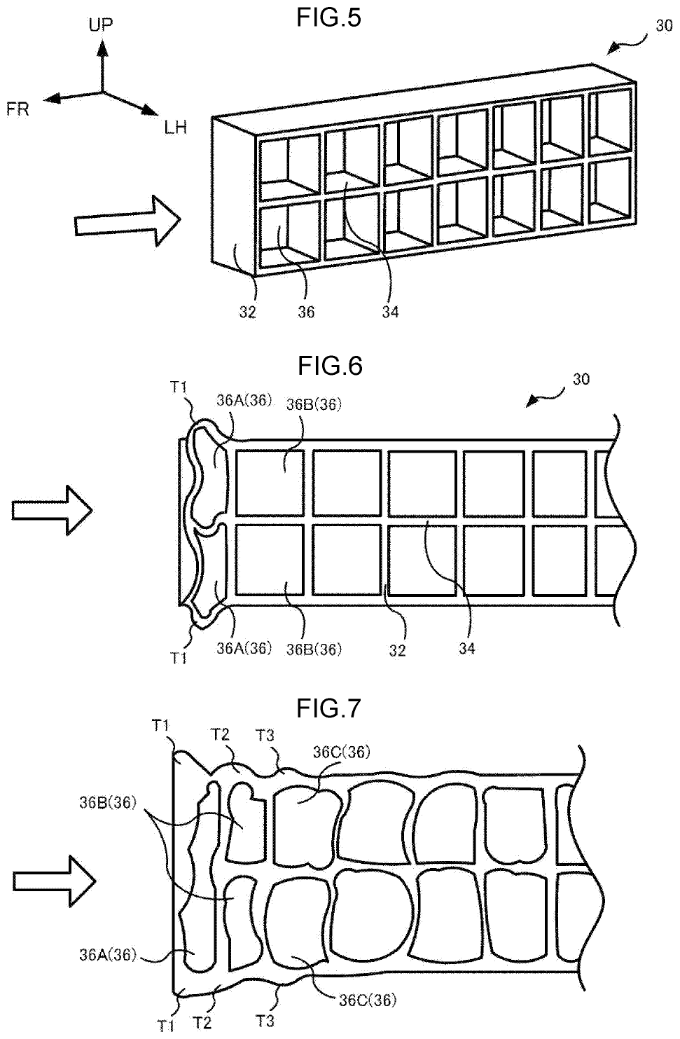

FIG. 5 is a perspective view of a front side member 30 of Comparative Example 1, viewed from an obliquely forward side of a vehicle. As illustrated in FIG. 5, the front side member 30 of Comparative Example 1 includes plural vertical ribs 32 extending in the vehicle up-down direction, in the vehicle front-rear direction. Further, the front side member 30 of Comparative Example 1 includes a lateral rib 34 extending in the vehicle front-rear direction, at a center in the vehicle up-down direction. The front side member 30 of Comparative Example 1 includes, for example, one lateral rib 34 and eight vertical ribs 32. Furthermore, the front side member 30 of Comparative Example 1 includes a total of 14 chambers 36, including seven chambers 36 each at a first stage and a second stage in the vehicle up-down direction, which are partitioned by the one lateral rib 34 and the eight vertical ribs 32.

In the front side member 10 of the first exemplary embodiment described above, the hollowed-out portions 22 are provided at the ribs 20, whereas the vertical ribs 32 of the front side member 30 of Comparative Example 1 are not provided with hollowed-out portions. In the front side member 30 of Comparative Example 1 including the vertical ribs 32 that are not provided with hollowed-out portions as described above, analysis was performed by applying a predetermined impact load from the vehicle front side.

FIG. 6 is a side view schematically illustrating an analysis result when a collision load has been applied to the front side member 30 of Comparative Example 1 in FIG. 5. As illustrated in FIG. 6, first chambers 36A from the vehicle front side, which are provided in the two stages in the vehicle up-down direction, were deformed in convex shapes that became convexities T1 toward both outer sides in the vehicle up-down direction due to the collision load. However, the second chambers 36B that are adjacent to the first chambers 36A did not undergo deformation that was dragged along by the deformation of the first chambers 36A. Namely, when the first chambers 36A were broken, deformation due to the breakage within the first chambers 36A was completed.

FIG. 7 is a diagram schematically illustrating an analysis result when the collision load was further applied to the front side member 30 of Comparative Example 1 from a state in FIG. 6. As illustrated in FIG. 7, when the collision load is further applied from the state illustrated in FIG. 6, in the front side member 30, the second chambers 36B and third chambers 36C provided in the two stages in the vehicle up-down direction were also deformed in convex shapes that became convexities T2, T3 toward both outer sides in the vehicle up-down direction, similarly to the first chambers 36A. Namely, due to the collision load, deformation of the second chambers 36B and the third chambers 36C due to breakage within the respective chambers was also completed, similarly to the first chambers 36A.

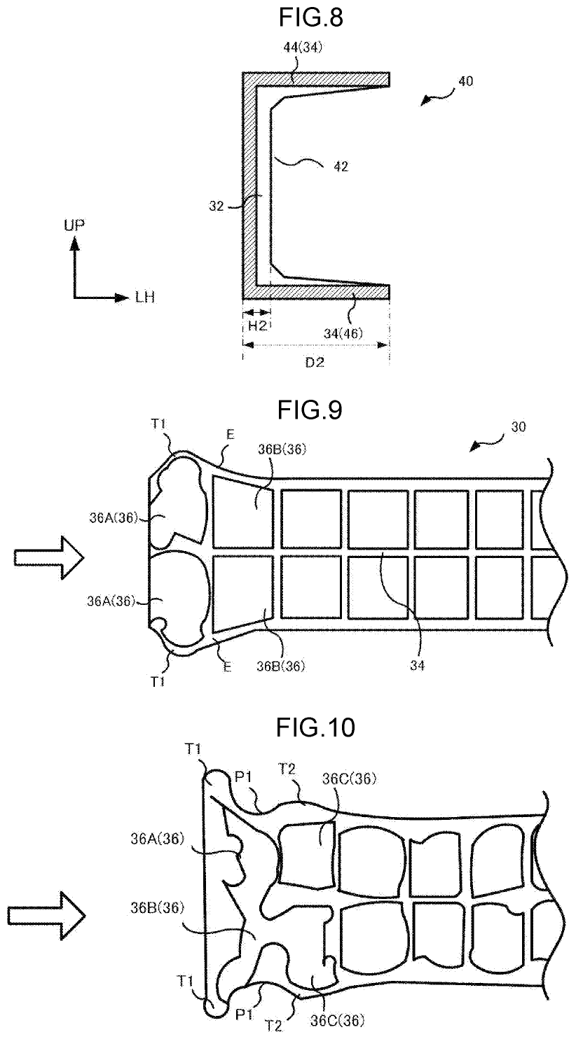

FIG. 8 is a vertical cross-sectional view of a front side member 40 of Comparative Example 2. As illustrated in FIG. 8, in the front side member 40 of Comparative Example 2, hollowed-out portions 42 are further provided in the configuration of the front side member 30 of Comparative Example 1 illustrated in FIG. 5. The minimum rib height H of the hollowed-out portions 22 of the first exemplary embodiment described above is set to be equal to or greater than half of the width direction dimension D of the upper wall 114 and the lower wall 116 (H≥D/2), whereas a minimum rib height H2 of the hollowed-out portions 42 of Comparative Example 2 is set to be smaller than half a width direction dimension D2 of an upper wall 44 and a lower wall 46 (H2<D2/2). Further, in the hollowed-out portions 42 of Comparative Example 2, a leading end is hollowed out in a generally rectangular shape, and, although not illustrated in the drawings, a width direction of the hollowed-out portions 42 is hollowed out so as to be smaller on progression toward the vehicle rear.

In the front side member 40 of Comparative Example 2 having the hollowed-out portions 42 that are larger than in the first exemplary embodiment as described above, analysis was performed by applying a predetermined impact load from the vehicle front side, similarly to the front side member 30 of Comparative Example 1. It should be noted that, in Comparative Example 2, since the hollowed-out portions 42 are provided, an impact load required for axial compression of the front side member 40, namely a crushing load required for crushing of the respective chambers 36, is reduced in comparison to Comparative Example 1. In other words, since the hollowed-out portions 42 are not provided in the front side member 30 of Comparative Example 1, the crushing load required for crushing of the respective chambers 36 is increased in comparison to Comparative Example 2.

FIG. 9 is a side view schematically illustrating an analysis result when a collision load has been applied to the front side member 40 of Comparative Example 2. As illustrated in FIG. 9, the first chambers 36A from the vehicle front side, which are provided in the two stages in the vehicle up-down direction, were deformed in convex shapes that became convexities T1 toward both outer sides in the vehicle up-down direction due to the collision load. Further, in the second chambers 36B that are adjacent to the first chambers 36A, the upper wall 44 and the lower wall 46 were deformed toward the outer sides as indicated by arrow E by being dragged along by the deformation of the first chambers 36A.

FIG. 10 is a diagram schematically illustrating an analysis result when a collision load has been further applied to the front side member 40 of Comparative Example 2 from a state in FIG. 9. As illustrated in FIG. 10, when the collision load is further applied from the state illustrated in FIG. 9, in the front side member 40, the second chambers 36 provided in the two stages in the vehicle up-down direction were deformed in concave shapes that became convexities toward the inner side in the vehicle up-down direction (concavities P1 toward the outer sides). Further, the third chambers 36C that are adjacent to the second chambers 36B were deformed in convex shapes that became convexities T2 toward both outer sides in the vehicle up-down direction, similarly to the first chambers 36A. Thus, in Comparative Example 2, different deformation occurred in the order of convex shapes, concave shapes, and convex shapes.

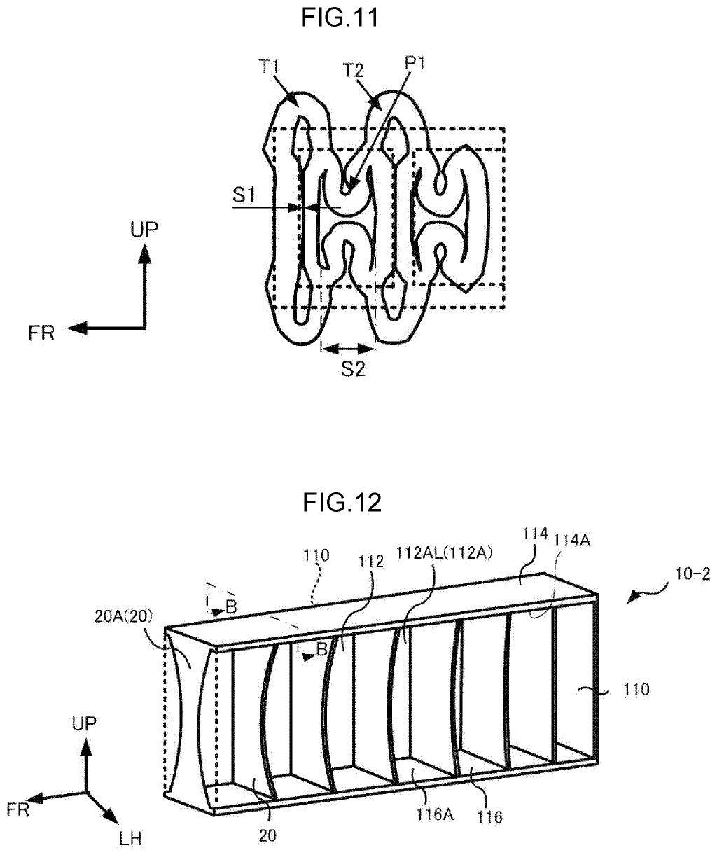

FIG. 11 is a side view schematically illustrating a state in which incomplete crushing has occurred. As illustrated in FIG. 11, in a case in which deformation in different shapes has occurred in the order of the convexities T1, the concavities P1, and the convexities T2, for the portions that have been deformed in the convexities T1, T2, no incomplete crushing has occurred at the interior of the front side member in the vehicle front-rear direction, as illustrated by arrow S1. On the other hand, for the portions that have been deformed in the concavities P1, there are cases in which incomplete crushing occurs in the vehicle front-rear direction due to fragments remaining at the interior of the front side member, as illustrated by arrow S2. When incomplete crushing occurs, vehicle deformation (stroke) cannot be sufficiently achieved by an amount corresponding to the amount of the incomplete crushing, and the energy absorption efficiency in the front side member decreases.

As described above, in the configuration of the front side member 40 of Comparative Example 2, since deformation in a concave shape occurs, there is a possibility that incomplete crushing may occur. On the other hand, in the front side member 30 of Comparative Example 1, since deformation in a convex shape occurs but deformation in a concave shape does not occur, incomplete crushing can be reduced. However, since the front side member 30 of Comparative Example 1 is not provided with hollowed-out portions, there are cases in which the crushing load in the respective chambers 36 becomes too large an intended energy absorption amount cannot be secured, even if occurrence of incomplete crushing can be suppressed.

As illustrated in FIG. 3, in the front side member 10 of the first exemplary embodiment, the minimum rib height H of the ribs 20 is set to be equal to or greater than half of the width direction dimension D of the upper wall 114 and the lower wall 116 (H≥ D/2). By adjusting the minimum rib height H, namely, a hollowing-out amount of hollowed-out portions 22 in this manner, the crushing load in the chambers 24 partitioned by the ribs 20 can be controlled, and therefore, an intended energy absorption amount can be secured. More specifically, by setting the minimum rib height H to be higher than that of Comparative Example 2, or in other words, by setting the hollowing-out amount of the hollowed-out portions 22 to be smaller than that of Comparative Example 2, occurrence of deformation in a concave shape can be suppressed. Consequently, an intended energy absorption amount can be secured while reducing a decrease in energy absorption efficiency due to incomplete crushing.

Further, in the front side member 10 of the first exemplary embodiment, the minimum rib height H is set so as to increase toward the vehicle rear. Namely, the hollowing-out amount of the hollowed-out portions 22 decreases toward the vehicle rear. Consequently, since the crushing load increases from the vehicle front side of the front side member 10 toward the rear, the crushing can be made easier to occur in order from the vehicle front side, and robustness of deformation during a collision can be improved.

Furthermore, according to the front side member 10 of the first exemplary embodiment, since the cross-sectional shape thereof is a U-shaped cross-sectional shape and the opening 110 is provided at the outer side in the vehicle width direction, a wall is present at the inner side in the vehicle width direction. Consequently, flying of fragments toward, for example, the power unit P disposed at the vehicle width direction inner side can be suppressed.

Moreover, according to the front side member 10 of the first exemplary embodiment, since the leading ends of the hollowed-out portions 22 provided at the ribs 20 are hollowed out in an arc shape, a central portion of the front side member in the vehicle up-down direction is more easily crushed, and convex deformation that becomes convexities toward the outer sides at the wall surfaces in the vehicle up-down direction occurs more easily.

### Second Exemplary Embodiment

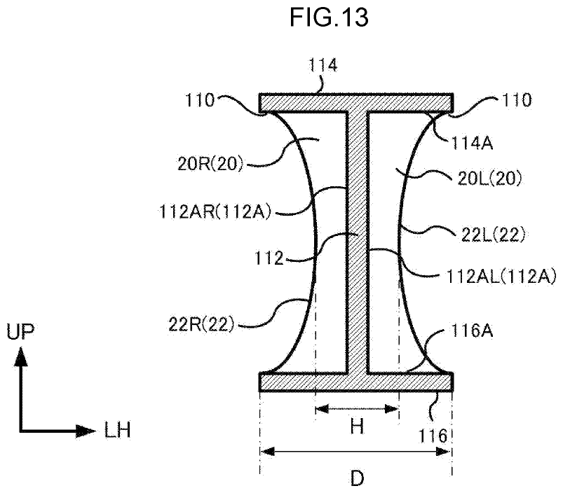

Next, explanation follows regarding a front side member 10-2 according to a second exemplary embodiment of the present invention. It should be noted that configurations similar to those of the first exemplary embodiment are denoted by the same reference numerals, explanation thereof is omitted, and only configurations that are different are described. FIG. 12 is a perspective view of the front side member 10-2 according to the second exemplary embodiment of the present invention, viewed from an obliquely forward side of a vehicle, and FIG. 13 is a cross-sectional view taken along line B-B in FIG. 12.

As illustrated in FIG. 12 and FIG. 13, the front side member 10-2 of the second exemplary embodiment has an H-shaped cross-sectional shape, and the opening 110 is provided at each of the inner side surface 10A and the outer side surface 10B in the vehicle width direction (refer to FIG. 1). Namely, the front side member 10-2 includes the bottom wall 112 at a vehicle width direction central portion, an outer side (left side) surface of the bottom wall 112 is a left side bottom surface 112AL, and an inner side (right side) surface thereof is a right side bottom surface 112AR.

Further, as illustrated in FIG. 13, the front side member 10-2 includes left ribs 20L at an outer side (left side) in the vehicle width direction and right ribs 20R at an inner side (right side) in the vehicle width direction, and respectively includes left hollowed-out portions 22L at the left ribs 20L and right hollowed-out portions 22R at the right ribs 20R. In the second exemplary embodiment, among heights along the vehicle width direction of the left rib 20L and the right rib 20R in combination, a height at a lowest position is defined as the minimum rib height H. Similarly to the first exemplary embodiment, the minimum rib height H is set to be equal to or greater than half of the width direction dimension D, namely, H≥ D/2.

Further, similarly to the first exemplary embodiment, in the front side member 10-2, the minimum rib height H is set to be higher on progression toward the vehicle rear. In other words, the width direction of the left hollowed-out portions 22L and the right hollowed-out portions 22R is hollowed out so as to be smaller on progression toward the vehicle rear. Furthermore, the leading ends of the left hollowed-out portions 22L and the right hollowed-out portions 22R are hollowed-out in a circular shape. It should be noted that the leading ends may also be hollowed out in a linear shape in the second exemplary embodiment, similarly as in the first exemplary embodiment.

It should be noted that, although the ribs 20 include the hollowed-out portions 22 in which the leading end is hollowed out in an arc shape in the present exemplary embodiment as illustrated in FIG. 12, the present disclosure is not limited thereto. Similarly to the first exemplary embodiment, the leading ends of the left hollowed-out portions 22L and the right hollowed-out portions 22R of the hollowed-out portions 22-2 may be hollowed out in, for example, a linear shape (refer to FIG. 4).

### Operation and Effects of Second Exemplary Embodiment

Next, explanation follows regarding operation and advantageous effects of the second exemplary embodiment.

In the front side member 10-2 according to the second exemplary embodiment, since a cross-sectional shape thereof is an H-shaped cross-sectional shape and the opening 110 is provided at the inner side and the outer side in the vehicle width direction, the bottom wall 112 is present at a vehicle width direction central portion of the front side member 10-2. Consequently, the crushing load can be controlled at both sides of the front side member 10-2 in the vehicle width direction.

Further, since the left ribs 20L and the right ribs 20R are provided in the front side member 10-2 according to the second exemplary embodiment, the crushing load in the chambers 24 partitioned by the left ribs 20L and the right ribs 20R can be controlled by adjusting the minimum rib height H. Consequently, an intended energy absorption amount can be secured. More specifically, by setting the minimum rib height H to be higher than in Comparative Example 2, occurrence of deformation in a concave shape can be suppressed. Consequently, accumulation of broken fragments due to the collision load applied to the front side member 10-2 at the interior of the front side member 10-2 can be suppressed, and a decrease in energy absorption efficiency due to incomplete crushing can be reduced. Accordingly, similarly to the first exemplary embodiment, an intended energy absorption amount can be secured while reducing a decrease in energy absorption efficiency due to incomplete crushing.

Furthermore, since the minimum rib height H is also set so as to increase toward the vehicle rear in the front side member 10-2 according to the second exemplary embodiment, the crushing load increases from the vehicle front side of the front side member 10-2 toward the vehicle rear. Consequently, the crushing can be made easier to occur in order from the vehicle front side, and robustness of deformation during a collision can be improved.

Moreover, since the leading ends of the left hollowed-out portions 22L and the right hollowed-out portions 22R are also hollowed out in an arc shape in the front side member 10-2 according to the second exemplary embodiment, a central portion of the front side member 10-2 in the vehicle up-down direction is more easily crushed, and convex deformation that becomes convexities toward the outer sides at the wall surfaces in the vehicle up-down direction occurs more easily.

### Supplementary Explanation

It should be noted that, although the chambers 24 are provided in one stage in the vehicle up-down direction in the exemplary embodiments described above, the present disclosure is not limited thereto. For example, two stages may be provided similarly to Comparative Example 1 and Comparative Example 2.

Further, in the exemplary embodiments described above, the pair of left and right front side members 10, 10-2, the pair of left and right suspension towers 18, and peripheral components of the pair of left and right suspension towers 18, namely, the apron upper members 15, the fender aprons 16, and the dash panel 17, are integrally molded by aluminum die casting. However, the present disclosure is not limited thereto, and the front side members 10, 10-2 may be molded separately from the other members. Furthermore, the present disclosure is not limited to aluminum die casting, and the molding may be carried out by die casting other than aluminum die casting.

Although explanation has been given above regarding exemplary embodiments of the present disclosure, the present disclosure is not limited to such exemplary embodiments. The exemplary embodiments and various modified examples may be used in appropriate combinations, and it will be obvious that various aspects may be implemented within a range that does not depart from the spirit of the present disclosure.

What is claimed is:

1. A front side member that extends in a vehicle front-rear direction at each of both left and right sides in a vehicle width direction, that has an open cross-sectional shape in which an opening is provided at at least one side thereof in the vehicle width direction, and that is integrally molded by die casting,
wherein the front side member comprises a plurality of ribs that connect a bottom surface at a side opposite from the opening, a lower surface of an upper wall in a vehicle up-down direction, and an upper surface of a lower wall in the vehicle up-down direction, and a minimum rib height of the ribs along the vehicle width direction is set to be equal to or greater than half of a width direction dimension of the upper wall and the lower wall.

2. The front side member according to claim 1, wherein the minimum rib height is set so as to increase toward a vehicle rear.

3. The front side member according to claim 1, wherein the open cross-sectional shape is a U-shaped cross-sectional shape, and the opening is provided at an outer side in the vehicle width direction.

4. The front side member according to claim 1, wherein the open cross-sectional shape is an H-shaped cross-sectional shape, and the opening is provided at each of an inner side and an outer side in the vehicle width direction.

5. The front side member according to claim 1, wherein the ribs comprise hollowed-out portions in which a leading end is hollowed out in an arc shape from an opening side in the vehicle width direction.
